(19) United States
(12) Patent Application Publication
(10) Pub. No.: US 2011/0269888 A1
(43) Pub. Date: Nov. 3, 2011

(54) FLAME RETARDANT MATERIAL AND A CABLE HAVING A CABLE SHEATH COMPOSED OF THE SAME

(75) Inventor: Antonio Pagliuca, Witney Oxfordshire (GB)

(73) Assignee: Tyco Electronics UK Ltd

(21) Appl. No.: 13/143,696

(22) PCT Filed: Jan. 4, 2010
(86) PCT No.: PCT/GB2010/050002

§ 371 Date: Jul. 7, 2011

(30) Foreign Application Priority Data
Jan. 7, 2009 (GB) 0900092.8

(51) Int. Cl. C08K 3/22

(52) U.S. Cl. 524/430

(57) ABSTRACT

A flame retardant material is disclosed comprising a polymer and at least two high purity, fine precipitated Al(OH)₃ flame retardant fillers, characterised by one having, in isolation, a specific surface area of at least 130% that of another; for example, a first AL(OH)₃ filler having, in isolation, a specific surface area of 4 to 8 m²/g (ideally between 6 to 8 m²/g) and a second AL(OH)₃ filler having, in isolation, a specific surface area of 8 to 14 m²/g (ideally between 10 to 12 m2/g).

This invention relates to a flame retardant material and a cable sheath comprising the same.

Use of high purity, fine precipitated Aluminium TriHydroxide Al(OH)₃ as a flame retardant filler for cable sheaths is known. Furthermore, such fillers are commercially available including those sold as Martinal® OL-111/LE, OL-107/LE, OL-104/LE, OL-104/A and OL-107/A from Albemarle Corporation®. Of those mentioned above, OL-104/A and OL-107/A are vinyl-silane treated.

In accordance with the present invention, there is provided a flame retardant material comprising a polymer and at least two high purity, fine precipitated Al(OH)₃ flame retardant fillers, characterised by one having, in isolation, a specific surface area of at least 130% that of another; for example, a first AL(OH)₃ filler having, in isolation, a specific surface area of 4 to 8 m²/g (ideally between 6 to 8 m²/g) and a second AL(OH)₃ filler having, in isolation, a specific surface area of 8 to 14 m²/g (ideally between 10 to 12 m²/g).

Without wishing to be bound by any theory, it is believed that the higher the specific surface area of a filler, then the greater chance of physical interaction with polymer chains (and vice versa) which will result in positive dispersion and good physical properties. However, for a very high specific surface area—as needed for good resistance to burning—physical interaction with polymer chains becomes too strong, reducing the elasticity and cold bending performance. The inventor has realised that by using a material comprising a combination of fillers with different specific surface areas, an unexpected synergy occurs whereby a good level of resistance to burning is maintained (e.g., compliance with UL VW-1 flammability testing) whilst furthermore maintaining good physical properties (e.g. strength greater than 10 Mpa, elongation approaching 200% and class leading cold bending performance).

The second AL(OH)₃ filler may, in isolation, have a specific surface area of at least 150% that of the first AL(OH)₃ filler. Furthermore, the first AL(OH)₃ filler may be subjected to a vinyl-silane treatment and wherein the second AL(OH)₃ filler is not so subjected. These measures appear to enhance the aforementioned synergy.

The ratio of the first to second filler is preferably between 1:1.27 and 1:1.67; more preferably between 1:1.37 and 1:1.57; and ideally 1:1.47.

The combined content of the first and second fillers in the material is preferably between 50% and 70%; more preferably between 55% and 65%; and ideally 60%.

The first AL(OH)₃ filler will preferably be Martinal 107A mentioned above.

The second AL(OH)₃ filler will preferably be Martinal 111LE mentioned above.

An embodiment of the present invention will now be described, with reference to the accompanying drawings, by way of example only.

In accordance with the present invention, there is provided a cable comprising a cable sheath having a flame retardant material comprising 30% low density polyethylene copolymer, 24% vinyl-silane treated Martinal OL-107A and 36% untreated Martinal OL-111/LE. Conventional additives such as anti-oxidants and colourants make up the remainder.

Such a material may be manufacturer by heating granulated polymer to between 120 and 140° C., and thereafter mixing the masticated polymer with first Martinal OL-107A and secondly Martina OL-111/LE using an intermixer (conventionally available mixing apparatus).

1. A flame retardant material comprising:
a polymer; and
at least two high purity, fine precipitated Al(OH)₃ flame retardant fillers, one having, in isolation, a specific surface area of at least 130% that of another.

2. A flame retardant material comprising:
a polymer; and
at least two high purity, fine precipitated Al(OH)₃ flame retardant fillers, a first AL(OH)₃ filler having, in isolation, a specific surface area of 4 to 8 m²/g and a second AL(OH)₃ filler having, in isolation, a specific surface area of 8 to 14 m²/g.

3. A material according to claim 2 wherein the first AL(OH)₃ filler has, in isolation, a specific surface area of 6 to 8 m²/g.

4. A material according to claim 2 wherein the second AL(OH)₃ filler has, in isolation, a specific surface area of 10 to 12 m²/g.

5. A material according to claim 2 wherein the second AL(OH)₃ filler has, in isolation, a specific surface area of at least 150% that of the first AL(OH)₃ filler.

6. A material according to claim 2 wherein the first AL(OH)₃ filler is subjected to a vinyl-silane treatment and wherein the second AL(OH)₃ filler is not so subjected.

7. A material according to claim 2 wherein the ratio of the first to second filler is between 1:1.27 and 1:1.67.

8. A material according to claim 7 wherein the ratio of the first to second filler is between 1:1.37 and 1:1.57.

9. A material according to claim 7 wherein the ratio of the first to second filler is 1:1.47.

10. A material according to claim 2 wherein the combined content of the first and second fillers in the material is between 50% and 70%.

11. A material according to claim 10 wherein the combined content of the first and second fillers in the material is between 55% and 65%.

12. A material according to claim 10 wherein the combined content of the first and second fillers in the material is 60%.

13. A material according to claim 2 wherein the first filler is Martinal 107A.

14. A material according to claim 2 wherein the second filler is Martinal 111LE.

15. A material according to claim 2 wherein the polymer is a low density polyethylene co-polymer or a blend thereof.

16. A cable having a cable sheath composed of material according to claim 2.
